(19) United States
(12) Patent Application Publication
(10) Pub. No.: US 2017/0369817 A1
(43) Pub. Date: Dec. 28, 2017

(54) HARD SURFACE CLEANING COMPOSITIONS

(71) Applicant: The Procter & Gamble Company, Cincinnati, OH (US)

(72) Inventor: Geert Andre DELEERSNYDER, Wielsbeke (BE)

(21) Appl. No.: 15/630,975

(22) Filed: Jun. 23, 2017

(30) Foreign Application Priority Data
Jun. 27, 2016 (EP) 16176324.8

(51) Int. Cl. C11D 1/831; C11D 1/75; C11D 1/14; C11D 3/37; C11D 3/00

(52) U.S. Cl. CPC C11D 1/831; C11D 3/3746; C11D 3/0047; C11D 1/143; C11D 1/75; C11D 3/0026

(57) ABSTRACT

The need for a liquid hard surface cleaning composition which provides improved grease removal and low suds is met using a combination of alkyl ethoxylated nonionic surfactant; an anionic surfactant selected from the group consisting of: an alkyl sulphate, a sulphonic acid or sulphonate surfactant, and mixtures thereof; and a co-surfactant in specific ratios.

### FIELD OF THE INVENTION

The present invention relates to a liquid hard surface cleaning composition exhibiting improved grease cleaning and less suds.

### BACKGROUND OF THE INVENTION

Hard surface cleaning compositions are used for cleaning and treating hard surfaces. Preferably, the hard surface cleaning composition is formulated to be an “all purpose” hard surface cleaning composition. That is, the hard surface cleaning composition is formulated to be suitable for cleaning as many different kinds of surfaces as possible. Hard surface cleaning compositions are typically diluted before use in a bucket before being applied to the surface being cleaned using a mop, sponge, cloth or similar device. Greasy residues are particularly challenging to remove using diluted hard surface cleaning compositions. In addition, prior art compositions which have been formulated for grease removal have typically been higher sudsing. Suds provide a signal to the user of good detergency power. However, suds remaining after use can result in the impression that further rinsing with clean water is needed. This is because high suds when mopping can result in an impression that soap residues remain on the hard surfaces after cleaning.

Hence, a need remains for a hard surface cleaning composition which provides improved greasy soil removal, especially when cleaning with diluted hard surface compositions, while resulting in less suds during use.

Examples of liquid compositions known in the art include liquid hard surface cleaning compositions comprising a sulphonated anionic surfactant, an amine oxide surfactant and an ethoxylated alcohol surfactant (EP-A-0 080 749 and EP-A-2447349) or compositions comprising an alkyl ethoxylated ether sulfate surfactant, a betaine surfactant, an amine oxide surfactant and an ethoxylated alcohol surfactant (WO 98/50508). Liquid hard surface cleaner concentrates and use solutions containing amine oxide surfactant, an anionic surfactant, a hydrophobically modified polymer surfactant, which provide viscous solutions upon dilution are also known (EP-A-0 595 590).

### SUMMARY OF THE INVENTION

The present invention relates to a hard surface cleaning composition comprising 1.8% to 20.0% by weight of the composition of a surfactant system, the surfactant system comprising: an ethoxylated nonionic surfactant, an anionic surfactant selected from the group consisting of: an alkyl sulphate, a sulphonic acid or sulphonate surfactant, and mixtures thereof; and a co-surfactant selected from the group consisting of: amine oxide surfactant, amphoteric surfactant, and mixtures thereof, wherein: the weight ratio of said anionic surfactant to said co-surfactant is greater than 2.75; the weight ratio of said anionic surfactant to said nonionic surfactant is from 0.1 to 1.0; the composition has a pH from 7.0 to 12.0; and the composition is free of enzymes.

### DETAILED DESCRIPTION OF THE INVENTION

The hard surface cleaning compositions of the present invention have been found to provide improved grease cleaning while being low sudsing.

As defined herein, “essentially free of” a component means that no amount of that component is deliberately incorporated into the composition. Preferably, “essentially free of” a component means that no amount of that component is present in the composition.

As defined herein, “stable” means that no visible phase separation is observed for a premix kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the composition, unless otherwise specified. All average values are calculated “by weight” of the composition, unless otherwise expressly indicated.

All ratios are calculated as a weight/weight level of the active material, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

Liquid hard surface cleaning compositions:

By “liquid hard surface cleaning composition”, it is meant herein a liquid composition for cleaning hard surfaces found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

In a preferred embodiment, the liquid compositions herein are aqueous compositions. Therefore, they may comprise from 30% to 99.5% by weight of the total composition of water, preferably from 50% to 98% and more preferably from 80% to 97%.

The pH is preferably from 7.0 to 12, more preferably from 7.5 to 11.5, even more preferably from 9.5 to 11.3, most preferably 10 to 11. It is believed that the greasy soil and particulate greasy soil cleaning performance is further improved at these preferred alkaline pH ranges. Accordingly, the compositions herein may further comprise an acid or base to adjust pH as appropriate.

A suitable acid for use herein is an organic and/or an inorganic acid. A preferred organic acid for use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof. A typical level of such acids, when present, is from 0.01% to 5.0% by weight of the total composition, preferably from 0.04% to 3.0% and more preferably from 0.05% to 1.5%.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide. Other suitable bases include ammonia, ammonium carbonate, K₂CO₃, Na₂CO₃ and alkanolamines (such as monoethanolamine, triethanolamine, aminomethylpropanol, and mixtures thereof). Typical levels of such bases, when present, are from 0.01% to 5.0% by weight of the total composition, preferably from 0.05% to 3.0%, more preferably from 0.1% to 2.0%, and most preferably 0.5% to 2.0%.

The hard surface cleaning compositions of the present invention do not comprise enzymes, and are hence typically unsuitable for cleaning fabrics and the like.

### Surfactant System

The total amount of surfactant is from 1.8% to 20%, or from 2% to 16%, preferably from 2.5% to 14.0%, more preferably from 3.5% to 13.0% and most preferably from 5.0% to 12.0% by weight of the composition of said surfactant system.

The surfactant system comprises ethoxylated nonionic surfactant, anionic surfactant selected from the group consisting of: an alkyl sulphate, an alkyl alkoxylated sulphate, a sulphonic acid or sulphonate surfactant, and mixtures thereof, and co-surfactant selected from the group consisting of: amine oxide surfactant, amphoteric surfactant, and mixtures thereof.

For improved greasy soil removal, the weight ratio of said anionic surfactant to said co-surfactant is greater than 2.75, or from 2.75 to 20, preferably from 3.5 to 12, more preferably from 5 to 8; and the weight ratio of said anionic surfactant to said nonionic surfactant is from 0.2 to 1.0, preferably from 0.25 to 0.75, more preferably from 0.40 to 0.6. The weight ratio of said co-surfactant to said nonionic surfactant is preferably from 0.01 to 0.40, more preferably from 0.02 to 0.20, most preferably from 0.04 to 0.10.

### Ethoxylated Nonionic Surfactant

The hard surface cleaning composition can comprise from 1 wt % to 10 wt %, preferably from 1.5wt % to 8 wt %, more preferably from 2 wt % to 7 wt % and most preferably from 2 wt % to 6 wt % of the composition of ethoxylated nonionic surfactant.

Suitable ethoxylated nonionic surfactants are according to the formula RO-(EO)ₙH, wherein: R is a C₆ to C₁₈, preferably a C₈ to C₁₆, more preferably a C₈ to C₁₂ alkyl chain, or a C₆ to C₂₈ alkyl benzene chain; EO is an ethoxy unit, and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. R can be linear or branched alkyl chain. The ethoxylated nonionic surfactant preferably has no other alkoxylation other than ethoxylation.

Suitable ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2 ; R is a mixture of C₉ to C₁₁ alkyl chains, n is 10), Dobanol® 91-12 (HLB=14.5 ; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5 , Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the ethoxylated nonionic surfactants for use herein include condensation of corresponding alcohols with ethylene oxide, in the desired proportions. Such processes are well known to the person skilled in the art and have been extensively described in the art, including the OXO process and various derivatives thereof. Suitable ethoxylated fatty alcohol nonionic surfactants, produced using the OXO process, have been marketed under the tradename NEODOL® by the Shell Chemical Company. Alternatively, suitable ethoxylated nonionic surfactants can be prepared by other processes such as the Ziegler process, in addition to derivatives of the OXO or Ziegler processes.

More preferably, said ethoxylated nonionic surfactant is selected from the group consisting of: C₉₋₁₁ EO5 alkylethoxylate, C₁₂₋₁₄ EO5 alkylethoxylate, C₁₁ EO5 alkylethoxylate, C₁₂₋₁₄ EO21 alkylethoxylate, C₉₋₁₁ EO8 alkylethoxylate, C10EO8 alkylethoxylate, C₁₂₋₁₄ EO7 alkylethoxylate, and mixtures thereof, most preferably, said ethoxylated nonionic surfactant is selected from the group consisting of: C₁₁ EO5 alkylethoxylate, C₉₋₁₁ EO8 alkylethoxylate, C10EO8 alkylethoxylate, C₁₂₋₁₄ EO7 alkylethoxylate, and mixtures thereof.

### Anionic Surfactant:

The liquid hard surface cleaning composition comprises an anionic surfactant is selected from the group consisting of: an alkyl sulphate, a sulphonic acid or sulphonate surfactant, and mixtures thereof. The liquid hard surface cleaning composition can comprise from 0.05 wt % to 5 wt %, preferably from 0.1 wt % to 4 wt %, and most preferably from 1.5 wt % to 3.5 wt % of the sulphate and/or sulphonate anionic surfactant.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman. By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Exemplary surfactants are Triton™ X-200 from DOW.

Suitable sulphated or sulphonated anionic surfactant for use herein include alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Preferably the sulphated or sulphonated anionic surfactant is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof. Most preferred are alkylbenzene sulfonates, especially C₁₂₋₁₄ alkylbenzene sulfonate.

Typically, the liquid composition herein may comprise from 0.5% to 9.5% by weight of the total composition of said sulphated or sulphonated anionic surfactant, preferably from 1.0% to 5.0%, more preferably from 1.5% to 3.5% and most preferably from 2.0% to 3.0%.

In order to reduce foaming during use, the composition preferably comprises less than 6%, preferably less than 3%, more preferably less than 0.5% by weight of alkyl ether sulphate anionic surfactant.

### Co-Surfactant

The surfactant system according to the present invention comprises a co-surfactant selected from the group consisting of: amine oxide surfactant, amphoteric surfactant, and combinations thereof.

Preferably, the co-surfactant at least partially neutralises the negative charges of the sulphated and/or sulphonated anionic surfactant.

Preferably, said co-surfactant is uncharged or comprises positive and negative charges within the same molecule. More preferably, said co-surfactant is an (overall) uncharged polar surfactant (with a strong dipole moment) or comprises positive and negative charges within the same molecule. Even more preferably, said co-surfactant is an uncharged polar surfactant or comprises the same amount of positive and negative charges within the same molecule. Most preferably, said co-surfactant is not a cationic surfactant.

Preferred co-surfactants are selected from the group consisting of: amine oxide surfactants and betaine surfactants and mixtures thereof.

Suitable betaine and sulfobetaine surfactants are according to the formulae:

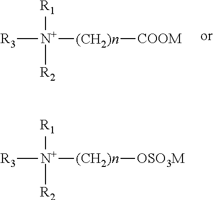

wherein: R₁ and R₂ are each independently linear or branched, saturated or unsaturated hydrocarbon chains of from 1 to 30 carbon atoms, preferably 1 to 20, more preferably 1 to 7 carbon atoms; R₃ is a linear or branched hydrocarbon chain of from 10 to 20 carbon atoms, preferably of from 10 to 18, more preferably 12 to 16 carbon atoms; n is an integer of from 1 to 20, preferably 1 to 10, more preferably 1 to 5; and M is H or an alkali metal, or mixtures thereof. Suitable betaine surfactant include coconut-dimethyl betaine commercially available under tradename Mackam35® from McIntyre.

Suitable amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel. Preferably, said co-surfactant is selected from the group consisting of: amine oxide surfactants betaine surfactants and mixtures thereof. More preferably, said co-surfactant is an amine oxide surfactant.

Typically, the liquid composition herein may comprise from 0.01% to 5.0% by weight of the total composition of said co-surfactant, preferably from 0.025% to 3.0%, more preferably from 0.05% to 2.5% and most preferably from 0.1% to 2.0%.

### Additional Nonionic Surfactant

The liquid hard surface cleaning composition can comprise additional nonionic surfactant. The additional nonionic surfactant is selected from the group consisting of: alkoxylated nonionic surfactant other than ethoxylated nonionic surfactant, ethoxylated alkoxylated nonionic surfactant, alkyl polyglycosides, and mixture thereof. Typically, the liquid hard surface cleaning composition may comprise from 1.0 wt % to 10.0 wt % by weight of the total composition of said additional nonionic surfactant, preferably from 3.0 wt % to 9.5 wt %, more preferably from 4.0 wt % to 9.0 wt % and most preferably from 5.0 wt % to 8.0 wt %.

The combination of ethoxylated alkoxylated nonionic surfactant with the ethoxylated nonionic surfactant has been found to result in improved shine, without a loss of cleaning efficacy. The improvement in shine is particularly noticeable when the ethoxylated alkoxylated nonionic surfactant and the ethoxylated nonionic surfactant are present in a weight ratio of from 0.03 to 0.5, preferably from 0.035 to 0.2 and more preferably from 0.04 to 0.09 especially when the ethoxylated alkoxylated nonionic surfactant is an esterified alkyl alkoxylated surfactant of formula I.

If present, the liquid hard surface cleaning composition can comprise the ethoxylated alkoxylated nonionic surfactant at a level of from 0.01 to 5% wt %, more preferably from 0.05 to 2 wt %, most preferably from 0.1 to 1.0 wt % of the composition. The ethoxylated alkoxylated nonionic surfactant is preferably selected from the group consisting of: esterified alkyl alkoxylated surfactant; alkyl ethoxy alkoxy alcohol, wherin the alkoxy part of the molecule is preferably propoxy, or butoxy, or propoxy-butoxy; polyoxyalkylene block copolymers, and mixtures thereof.

The preferred ethoxylated alkoxylated nonionic surfactant is an esterified alkyl alkoxylated surfactant of general formula (I):

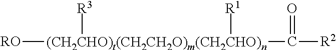

where

R is a branched or unbranched alkyl radical having 8 to 16 carbon atoms, preferably from 10 to 16 and more preferably from 12 to 15;

R³, R¹ independently of one another, are hydrogen or a branched or unbranched alkyl radical having 1 to 5 carbon atoms; preferably R³ and R¹ are hydrogen

R² is an unbranched alkyl radical having 5 to 17 carbon atoms; preferably from 6 to 14 carbon atoms

l, n independently of one another, are a number from 1 to 5 and

m is a number from 8 to 50; and

Preferably, the weight average molecular weight of the ethoxylated alkoxylated nonionic surfactant of formula (I) is from 950 to 2300 g/mol, more preferably from 1200 to 1900 g/mol.

R is preferably from 12 to 15, preferably 13 carbon atoms. R³ and R¹ are preferably hydrogen. l is preferably 5. n is preferably 1. m is preferably from 13 to 35, more preferably 15 to 25, most preferably 22. R² is preferably from 6 to 14 carbon atoms.

The hard surface cleaning composition of the invention provides especially good shine when the esterified alkyl akoxylated surfactant is as follows: R has from 12 to 15, preferably 13 carbon atoms, R³ is hydrogen, R¹ is hydrogen, l is 5, n is 1, m is from 15 to 25, preferably 22 and R² has from 6 to 14 carbon atoms and the alcohol ethoxylated has an aliphatic alcohol chain containing from 10 to 14, more preferably 13 carbon atoms and from 5 to 8, more preferably 7 molecules of ethylene oxide.

Another preferred ethoxylated alkoxylated nonionic surfactant is an alkyl ethoxy alkoxy alcohol, preferably wherein the alkoxy part of the molecule is propoxy, or butoxy, or propoxy-butoxy. More preferred alkyl ethoxy alkoxy alcohols are of formula (II):

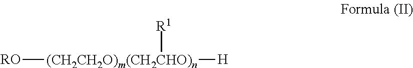

wherein:

R is a branched or unbranched alkyl radical having 8 to 16 carbon atoms;

R¹ is a branched or unbranched alkyl radical having 1 to 5 carbon atoms;

n is from 1 to 10; and m is from 6 to 35.

R is preferably from 12 to 15, preferably 13 carbon atoms. R¹ is preferably a branched alkyl radical having from 1 to 2 carbon atoms. n is preferably 1 to 5. m is preferably from 8 to 25. Preferably, the weight average molecular weight of the ethoxylated alkoxylated nonionic surfactant of formula (II) is from 500 to 2000 g/mol, more preferably from 600 to 1700 g/mol, most preferably 800 to 1500 g/mol.

The ethoxylated alkoxylated nonionic surfactant can be a polyoxyalkylene copolymer. The polyoxyalkylene copolymer can be a block-heteric ethoxylated alkoxylated nonionic surfactant, though block-block surfactants are preferred. Suitable polyoxyalkylene block copolymers include ethylene oxide/propylene oxide block polymers, of formula (III):

(EO)ₓ(PO)_{y}(EO)ₓ, or (PO)ₓ(EO)_{y}(PO)ₓ

wherein EO represents an ethylene oxide unit, PO represents a propylene oxide unit, and x and y are numbers detailing the average number of moles ethylene oxide and propylene oxide in each mole of product. Such materials tend to have higher molecular weights than most non-ionic surfactants, and as such can range between 1000 and 30000 g/mol, although the molecular weight should be above 2200 and preferably below 13000 to be in accordance with the invention. A preferred range for the molecular weight of the polymeric non-ionic surfactant is from 2400 to 11500 Daltons. BASF (Mount Olive, N.J.) manufactures a suitable set of derivatives and markets them under the Pluronic trademarks. Examples of these are Pluronic (trademark) F77, L62 and F88 which have the molecular weight of 6600, 2450 and 11400 g/mol respectively. An especially preferred example of a useful polymeric non-ionic surfactant is Pluronic (trademark) F77.

Other suitable ethoxylated alkoxylated nonionic surfactants are described in Chapter 7 of Surfactant Science and Technology, Third Edition, Wiley Press, ISBN 978-0-471-68024-6.

The ethoxylated alkoxylated nonionic surfactant provides a wetting effect of from 60 to 200, preferably from 75 to 150. The wetting effect is measured according to EN 1772, using 1 g/l of the ethoxylated alkoxylated nonionic surfactant in distilled water, at 23 ° C., with 2 g soda/l. Preferred ethoxylated alkoxylated nonionic surfactants include those sold by BASF under the “Plurafac” trademark, such as Plurafac LF 301 (wetting effect of 90 s), LF 401 (wetting effect of 115 s), LF 405 (wetting effect of 100 s), and LF 7319 (wetting effect of 100 s). It is believed that that the combination of an ethoxylated alkoxylated nonionic surfactant having the aforementioned wetting effect, with the additional nonionic surfactant and anionic surfactant, results in beading of the residual wash water on the hard surface, after cleaning, and hence, improved removal of the residual dirt during subsequent wiping. Moreover, the resultant beading results faster drying time and hence less slipperiness. In comparison, non-preferred ethoxylated alkoxylated nonionic surfactants, such as Plurafac LF 300 (wetting effect of 60) results in less shine and longer drying times.

### Optional Ingredients:

Thickener: The liquid hard surface cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated. Moreover, a high low shear viscosity improves the phase stability of the liquid cleaning composition, and especially improves the stability of the ethoxylated alkoxylated nonionic surfactant in compositions in the liquid hard surface cleaning composition.

Hence the compositions of the present invention preferably have a viscosity from 25 Pa·s to 1000 Pa·s, more preferably of from 50 Pa·s to 600 Pa·s, more preferably from 100 Pa·s to 500 Pa·s, even more preferably from 150 Pa·s to 400 Pa·s and most preferably from 150 Pa·s to Pa·s when measured at 20° C. with a AD1000 Advanced Rheometer from Atlas® shear rate 10 s⁻¹ with a coned spindle of 40 mm with a cone angle 2° and a truncation of ±60 μm.

Suitable thickeners include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

Other suitable thickeners are hydroxethylcelluloses (HM-HEC) preferably hydrophobically modified hydroxyethylcellulose. Suitable hydroxethylcelluloses (HM-HEC) are commercially available from Aqualon/Hercules under the product name Polysurf 76® and W301 from 3V Sigma.

Xanthan gum is one suitable thickener of use herein. Xanthan gum is a polysaccharide commonly used rheoligy modifier and stabilizer. Xanthan gum is produced by fermentation of glucose or sucroce by the xanthomonas campestris bacterium. Suitable Xanthan gum is commercially available under trade anem Kelzan T® from CP Kelco.

Hydrogenated castor oil is one suitable thickener of use herein. Suitable hydrogenated castor oil is available under trade name THIXCIN R from Elementis.

The most preferred thickener of use herein is a modified methacrylic acid/acrylic acid copolymer Rheovis® AT 120, which is commercially available from BASF.

When used, the liquid hard surface cleaning composition comprises from 0.1% to 10.0% by weight of the total composition of said thickener, preferably from 0.2% to 5.0%, more preferably from 0.2% to 2.5% and most preferably from 0.2% to 2.0%.

Chelating agent: The liquid hard surface cleaning composition can comprise a chelating agent or crystal growth inhibitor. Chelating agent can be incorporated into the compositions in amounts ranging from 0.05% to 5.0% by weight of the total composition, preferably from 0.1% to 3.0%, more preferably from 0.2% to 2.0% and most preferably from 0.2% to 0.4%.

Suitable phosphonate chelating agents include ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agent to be used herein is diethylene triamine penta methylene phosphonate (DTPMP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename (S,S)EDDS® from Palmer Research Laboratories. Most preferred biodegradable chelating agent is L-glutamic acid N,N-diacetic acid (GLDA) commercially available under tradename Dissolvine 47S from Akzo Nobel.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Additional polymers: The liquid hard surface cleaning composition may comprise an additional polymer. It has been found that the presence of a specific polymer as described herein, when present, allows further improving the grease removal performance of the liquid composition, especially during subsequent cleaning steps. Suitable polymers for use herein are disclosed in EP2272942 (09164872.5) and granted European patent EP2025743 (07113156.9).

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/poly acrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

The liquid hard surface cleaning composition may comprise from 0.005% to 5.0% by weight of the total composition of said polymer, preferably from 0.10% to 4.0%, more preferably from 0.1% to 3.0% and most preferably from 0.20% to 1.0%.

Fatty acid: The liquid hard surface cleaning composition may comprise a fatty acid or its salt. Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERA B1211.

Typically, the liquid hard surface cleaning composition may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Branched fatty alcohol: The liquid hard surface cleaning composition may comprise a branched fatty alcohol. Suitable branched fatty alcohols include the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the α position (i.e., position number 2) by an alkyl chain comprising from 1 to 10, preferably from 2 to 8 and more preferably 4 to 6 carbon atoms. Such suitable compounds are commercially available, for instance, as the Isofol® series such as Isofol® 12 (2-butyl octanol) or Isofol® 16 (2-hexyl decanol) commercially available from Sasol.

Typically, the liquid hard surface cleaning composition may comprise up to 2.0% by weight of the total composition of said branched fatty alcohol, preferably from 0.10% to 1.0%, more preferably from 0.1% to 0.8% and most preferably from 0.1% to 0.5%.

Solvent: The liquid hard surface cleaning compositions preferably comprises a solvent. Suitable solvents may be selected from the group consisting of: ethers and diethers having from 4 to 14 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁₆ glycol ethers; terpenes; and mixtures thereof.

Perfumes: The liquid hard surface cleaning compositions preferably comprise a perfume. Suitable perfumes provide an olfactory aesthetic benefit and/or mask any “chemical” odour that the product may have.

Other optional ingredients: The liquid hard surface cleaning compositions may comprise a variety of other optional ingredients depending on the technical benefit aimed for and the surface treated. Suitable optional ingredients for use herein include builders, other polymers, buffers, bactericides, hydrotropes, colorants, stabilisers, radical scavengers, abrasives, soil suspenders, brighteners, anti-dusting agents, dispersants, dye transfer inhibitors, pigments, silicones and/or dyes.

### Method of Cleaning a Surface:

The liquid hard surface cleaning compositions are suitable for cleaning household surfaces. In particular, such compositions are particularly useful for grease removal from such surfaces, and for improving surface shine, especially during cleaning.

For general cleaning of soiled hard surfaces, especially of floors, the preferred method of cleaning comprises the steps of:
a) diluting the liquid hard surface cleaning composition to a dilution level of from 0.1% to 2% by volume, and
b) applying the diluted composition to a hard surface.

In preferred embodiments, the liquid hard surface cleaning composition may be diluted to a level of from 0.3% to 1.5% by volume. The liquid hard surface cleaning composition may be diluted to a level of from 0.4% to 0.6% by volume, especially where the liquid hard surface cleaning composition has a total surfactant level of greater than or equal to 5% by weight. Where the liquid hard surface cleaning composition has a total surfactant level of less than 5% by weight, the liquid hard surface cleaning composition may be diluted to a level of from 0.7% to 1.4% by volume. In preferred embodiments, the liquid hard surface cleaning composition is diluted with water.

The dilution level is expressed as a percent defined as the fraction of the liquid hard surface cleaning composition, by volume, with respect to the total amount of the diluted composition. For example, a dilution level of 5% by volume is equivalent to 50 ml of the liquid hard surface cleaning composition being diluted to form 1000 ml of diluted composition.

The diluted composition can be applied by any suitable means, including using a mop, sponge, or other suitable implement.

The hard surface may be rinsed, preferably with clean water, in an optional further step. The liquid hard surface cleaning compositions result in improved grease removal.

Alternatively, and especially for particularly dirty or greasy spots, the liquid hard surface cleaning compositions can be applied neat to the hard surface. It is believed that the improved surface wetting provided by the neat composition results in further improved penetration of the stain, and especially greasy stains, leading to improved surfactancy action and stain removal.

By “neat”, it is to be understood that the liquid composition is applied directly onto the surface to be treated without undergoing any significant dilution, i.e., the liquid composition herein is applied onto the hard surface as described herein, either directly or via an implement such as a sponge, without first diluting the composition. By significant dilution, what is meant is that the composition is diluted by less than 10 wt %, preferably less than 5 wt %, more preferably less than 3 wt %. Such dilutions can arise from the use of damp implements to apply the composition to the hard surface, such as sponges which have been “squeezed” dry.

In a preferred embodiment of the present invention said hard surface is inclined or vertical. Inclined or vertical hard surfaces include mirrors, lavatory pans, urinals, drains, waste pipes and the like.

In another preferred embodiment of the present invention said method of cleaning a hard surface includes the steps of applying, preferably spraying, said liquid composition onto said hard surface, leaving said liquid composition to act onto said surface for a period of time to allow said composition to act, with or without applying mechanical action, and optionally removing said liquid composition, preferably removing said liquid composition by rinsing said hard surface with water and/or wiping said hard surface with an appropriate instrument, e.g., a sponge, a paper or cloth towel and the like.

### Methods:

A) pH measurement:

The pH is measured on the neat composition, at 25° C., using a Sartarius PT-10P pH meter with gel-filled probe (such as the Toledo probe, part number 52 000 100), calibrated according to the instructions manual.

B) Grease cleaning:

A representative grease/particulate-artificial soil is prepared by blending in equal parts, arachidi oil, sunflower oil, and corn oil. 49 parts of the oil blend is mixed with 1 part of particulate soil (“House Wife Soil” with Carbon Black produced by Empirical Manufacturing company, Reinhold drive, Cincinnati, Ohio, United States) Enamel tiles are prepared by applying 0.6 g of the representative grease/particulate-artificial soil and ageing for 3 hours 10 minutes at 135° C. The tiles are then left to cool to ambient temperature.

The test composition is evaluated by applying 5 ml of the test composition directly to a sponge (Yellow cellulose sponge, “type Z”, supplied by Boma, Nooderlaan 131, 2030 Antwerp, Belgium), and then cleaning the tile with the sponge using a forward-backward motion at 20 strokes per minute at a constant pressure of 1.4 kN/m². The number of strokes required to clean the tile is recorded.

The Cleaning Index is calculated as follows:

$$\frac{number of strokes required for the reference product}{number of strokes required for the test product} \times 100$$

C) Suds height:

Hard surface cleaning compositions are used neat and dilute. Suds are an important aesthetic property of the composition which influences the consumer perception for ease of cleaning and ease of rinsing. These suds methods are designed to test the suds profile of hard surface cleaning compositions under conditions which are analogous to this in-home use situation.

C1) Suds height in bucket test:

This test is to evaluate suds formation and suds longevity when the hard surface cleaning composition is diluted, for instance in a bucket prior to cleaning a hard surface. Ideally, suds which are generated disperse in a short time since suds during use gives the impression that too much surfactant residue remains on the treated surface.

Ten liters of soft water having a water hardness of less than 86 ppm [5 gpg] is prepared at a temperature of at 35° C. 24 g of the hard surface cleaning composition is added to a clean 3 L graduated beaker. 2 L of the prepared soft water is poured into the beaker and the suds height is immediately measured. The suds height is remeasured after 30 seconds, 1 minute, 2 minutes, and 4 minutes.

C2) Suds height during sponge use:

This test is to evaluate suds duration and suds longevity when a sponge is immersed in a bucket of diluted hard surface cleaning composition. This test is representative of when a sponge or other cleaning implement is used to clean a hard to remove stain on the surface being treated.

A sponge is rinsed under a flow of soft water (water hardness of less than 86 ppm [5 gpg]) at a temperature of approximately 35° C. A 3 L beaker of water of diluted hard surface cleaning composition is prepared in the same manner as for method E1 (Suds in bucket test). The sponge is squeezed in the solution of diluted hard surface cleaning composition and the sponge taken out and squeezed again, just above the solution. The immersion and squeezing of the sponge was repeated an additional 9 times (10 times in total), in quick succession, in the same manner, and the suds height immediately measured. The suds height is remeasured after 30 seconds, 1 minute, 2 minutes, and 4 minutes.

### EXAMPLES

Examples A to E were prepared as comparative formulae. The comparative examples either had a ratio of anionic to nonionic surfactant of greater than 1.0, or had a ratio of anionic to co-surfactant of less than 2.75. Examples 1 to 6 were formulated with the same level of total surfactant, but having a ratio of anionic to nonionic surfactant within the range 0.15 to 1.0, and having a ratio of anionic to co-surfactant greater than 2.75. Examples 1 to 6 provided improved grease cleaning in comparison to the comparative compositions A to E:

| | Ex A* | Ex 1 | Ex 2 | Ex B* |
|---|---|---|---|---|
| | wt % | wt % | wt % | wt % |
| C9/11 EO8¹ | 4.5 | 5.0 | 6.0 | 7.0 |
| HLAS | 5.0 | 4.0 | 3.0 | 2.0 |
| C12-14 Amine Oxide² | 0.5 | 1.0 | 1.0 | 1.0 |
| Hydrophobically modified- | 0.8 | 0.8 | 0.8 | 0.8 |
| polyacrylate³ | | | | |
| Na₂CO₃ | 0.55 | 0.55 | 0.55 | 0.55 |
| Perfume | 1.0 | 1.0 | 1.0 | 1.0 |
| pH (using 50 wt % sodium | 10.3 | 10.3 | 10.3 | 10.3 |
| hydroxide in water) | | | | |
| Water | bal. | bal. | bal. | bal. |
| Ratio anionic:co-surfactant | 10 | 4 | 3 | 2 |
| Ratio anionic:nonionic | 1.11 | 0.80 | 0.50 | 0.29 |
| surfactant | | | | |
| Grease cleaning index | 93 | 142 | 125 | 100 |
| | Ex A* | Ex 3 | Ex 4 | Ex C* |
| | wt % | wt % | wt % | wt % |
| C9/11 EO8¹ | 4.5 | 6.0 | 7.0 | 9.0 |
| HLAS | 5.0 | 3.5 | 2.5 | 0.5 |
| C12-14 Amine Oxide² | 0.5 | 0.5 | 0.5 | 0.5 |
| Hydrophobically modified- | 0.8 | 0.8 | 0.8 | 0.8 |
| polyacrylate³ | | | | |
| Na₂CO₃ | 0.55 | 0.55 | 0.55 | 0.55 |
| Perfume | 1.0 | 1.0 | 1.0 | 1.0 |
| pH (using 50 wt % sodium | 10.3 | 10.3 | 10.3 | 10.3 |
| hydroxide in water) | | | | |
| Water | bal. | bal. | bal. | bal. |
| Ratio anionic:co-surfactant | 10 | 7 | 5 | 1 |
| Ratio anionic:nonionic | 1.11 | 0.58 | 0.36 | 0.06 |
| surfactant | | | | |
| Grease cleaning index | 93 | 172 | 154 | 100 |
| | Ex D* | Ex 5 | Ex 6 | Ex E* |
| | wt % | wt % | wt % | wt % |
| C9/11 EO8¹ | 4.9 | 5.9 | 6.9 | 8.9 |
| HLAS | 5.0 | 4.0 | 3.0 | 1.0 |
| C12-14 Amine Oxide² | 0.1 | 0.1 | 0.1 | 0.1 |
| Hydrophobically modified- | 0.8 | 0.8 | 0.8 | 0.8 |
| polyacrylate³ | | | | |
| Na₂CO₃ | 0.55 | 0.55 | 0.55 | 0.55 |
| Perfume | 1.0 | 1.0 | 1.0 | 1.0 |
| pH (using 50 wt % sodium | 10.3 | 10.3 | 10.3 | 10.3 |
| hydroxide in water) | | | | |
| Water | bal. | bal. | bal. | bal. |
| Ratio anionic:co-surfactant | 50 | 40 | 30 | 10 |
| Ratio anionic:nonionic | 1.02 | 0.68 | 0.43 | 0.11 |
| surfactant | | | | |
| Grease cleaning index | 100 | 115 | 112 | 87 |

*Comparative
¹nonionic surfactant commercially available from Shell.
²amine oxide nonionic surfactant commercially available from Huntsman
³Rheovis AT 120 thickener commercially available from BASF

Comparative formula F had the same formulation as Example 2, with the exception that the HLAS surfactant was replaced with the same level of C24AE3S anionic surfactant. As can be seen by comparing the suds heigh improving the grease removal performance t both after pouring and after squeezing, the use of a sulphonic acid surfactant results in less sudsing than AES surfactants:

| | Ex 2 | Ex F* |
|---|---|---|
| | wt % | wt % |
| C9/11 EO8¹ | 6.0 | 6.0 |
| HLAS | 3.0 | — |
| C24AE3S | — | 3.0 |
| C12-14 Amine Oxide² | 1.0 | 1.0 |
| Hydrophobically modified- | 0.8 | 0.8 |
| polyacrylate³ | | |
| Na₂CO₃ | 0.55 | 0.55 |
| Perfume | 1.0 | 1.0 |
| pH (using 50 wt % sodium | 10.3 | 10.3 |
| hydroxide in water) | | |
| Water | bal. | bal. |
| Suds height during sponge | 2.6 | 3.0 |
| use (cm after 30 s) | | |
| Suds height after pouring | 1.75 | 2.4 |
| (cm after 30 s) | | |

The following are examples of liquid hard surface cleaning compositions of the present invention:

| | A | B | C | D | E | F | G | H | I |
|---|---|---|---|---|---|---|---|---|---|
| | wt % | wt % | wt % | wt % | wt % | wt % | wt % | wt % | wt % |
| C9/11 EO8¹ | 1.2 | — | 7 | — | — | — | 3 | 6 | 4 |
| C9/11EO5⁴ | — | 5 | — | 3.5 | — | — | — | — | — |
| C13/15 EO30⁵ | — | — | — | 3.5 | — | — | — | — | — |
| C8/10 EO8⁶ | 1.2 | 1 | — | — | 7 | 6 | 3 | — | — |
| NaLAS⁷ | 0.36 | 0.6 | 3 | — | — | 2.6 | — | 2.64 | 1.5 |
| NAPS⁸ | — | — | — | 3.1 | 3 | — | 2.6 | — | — |
| C12-14 Amine | | 0.15 | 1 | 1.1 | — | 0.5 | — | 0.36 | 0.3 |
| Oxide² | | | | | | | | | |
| C12-14 Betaine⁹ | 0.12 | — | — | — | 1 | — | 0.36 | — | — |
| Ethoxylated | 0.2 | — | 0.5 | 1 | 0.4 | 0.3 | 0.5 | 0.5 | 0.5 |
| alkoxylated non- | | | | | | | | | |
| ionic surfactant¹⁰ | | | | | | | | | |
| Hydrophobically | — | 0.5 | 0.75 | — | — | — | 0.7 | 0.65 | 0.65 |
| modified- | | | | | | | | | |
| polyacrylate³ | | | | | | | | | |
| HM-HEC¹¹ | — | — | — | 0.6 | 0.8 | — | — | — | — |
| Xanthan gum¹² | — | — | — | — | — | 0.42 | — | — | — |
| Na₂CO₃ | 0.1 | 0.1 | 0.75 | 0.1 | 0.3 | 0.5 | 0.55 | 0.4 | 0.1 |
| Citric Acid | 0.3 | 0.15 | 0.3 | 0.75 | 0.75 | 0.3 | 0.3 | 0.3 | 0.3 |
| Caustic | 0.25 | 0.3 | 0.72 | 0.54 | 0.5 | 0.3 | 0.65 | 0.65 | 0.25 |
| Monoethanolamine | — | — | — | — | — | — | — | — | 2.0 |
| Aminomethyl | 0.5 | — | — | — | — | — | — | — | — |
| propanol¹³ | | | | | | | | | |
| TPK Fatty Acid | 0.15 | — | 1 | 0.2 | 0.5 | 0.5 | 0.4 | 0.4 | 1 |
| 2-butyl octanol¹⁴ | — | 0.05 | 0.1 | 0.2 | 0.3 | 0.5 | — | — | 0.1 |
| 2-hexyl decanol¹⁵ | — | — | — | — | — | — | 0.1 | — | — |
| DTPMP¹⁶ | 0.1 | 0.15 | | — | — | 0.2 | — | 0.3 | 0.3 |
| DTPA¹⁷ | — | — | 0.25 | — | — | — | 0.25 | — | — |
| GLDA¹⁸ | — | — | — | 0.3 | 0.3 | — | — | — | — |
| IPA¹⁹ | — | — | — | — | — | 2 | — | — | — |
| n-BPP²⁰ | — | — | — | — | 2 | — | — | — | — |
| n-BP²¹ | — | — | — | 4 | 2 | — | — | — | — |
| Minors and Water | up to | up to | up to | up to | up to | up to | up to | up to | up to |
| | 100% | 100% | 100% | 100% | 100% | 100% | 100% | 100% | 100% |
| pH | 10.8 | 10.3 | 10.3 | 9.5 | 9 | 10.5 | 10.3 | 10.5 | 11.3 |

⁴nonionic surfactant commercially available from ICI or Shell.
⁵nonionic surfactant commercially available from BASF
⁶nonionic surfactant commercially available from Sasol
⁷sodium linear alkylbenzene sulphonate commercially available from Huntsman
⁸sodium paraffin sulphonate commercially available from ICS
⁹amphoteric surfactant commercially available from MC Intyre group
¹⁰Plurafac LF402, supplied by BASF, Ludwisghaven, Germany
¹¹Hydrophobically modified hydroxyethylcellulose (cetylhydroxethylcellulose)
¹²commercially available from CP Kelco
¹³Supplied by Dow Chemicals
¹⁴commercially available from Sasol as Isofol 12 ®.
¹⁵commercially available from Sasol as Isofol 16 ®.
¹⁶diethylenetriamine penta(methylene phosphonic acid), commercially available from Zschinmer & Schwarz, Mohsdorf
¹⁷diethylenetriaminepentaacetic acid, Trilon ®, commercially available from BASF
¹⁸Tetrasodium Glutamate Diacetate, commercially available from Akzo Nobel
¹⁹isopropanol, commercially available from JT Baker
²⁰butoxy propoxy propanol, commercially available from Dow Chemicals
²¹normal butoxy propanol commercially available from Dow Chemicals

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hard surface cleaning composition comprising about 1.8% to about 20.0% by weight of the composition of a surfactant system, the surfactant system comprising:
a) an ethoxylated nonionic surfactant,
b) an anionic surfactant selected from the group consisting of: an alkyl sulphate, a sulphonic acid or sulphonate surfactant, and mixtures thereof; and
c) a co-surfactant selected from the group consisting of: amine oxide surfactant, amphoteric surfactant, and mixtures thereof,
wherein:
the weight ratio of said anionic surfactant to said co-surfactant is greater than about 2.75;
the weight ratio of said anionic surfactant to said nonionic surfactant is from about 0.15 to about 1.0;
the composition has a pH from about 7.0 to about 12.0; and
the composition is free of enzymes.

2. The hard surface cleaning composition according to claim 1, wherein the weight ratio of said anionic surfactant to said co-surfactant is from about 2.75 to about 20.

3. The hard surface cleaning composition according to claim 1, wherein the weight ratio of said anionic surfactant to said nonionic surfactant is from about 0.2 to about 1.0.

4. The hard surface cleaning composition according to claim 1, wherein the weight ratio of said co-surfactant to said nonionic surfactant is from about 0.01 to about 0.40.

5. The hard surface cleaning composition according to claim 1 wherein said ethoxylated nonionic surfactant is selected from the group consisting of: C₉₋₁₁ EO5 alkylethoxylate, C₁₂₋₁₄ EO5 alkylethoxylate, C₁₁ EO5 alkylethoxylate, C₁₂₋₁₄ EO21 alkylethoxylate, C₉₋₁₁ EO8 alkylethoxylate, C10EO8 alkylethoxylate, C₁₂₋₁₄ EO7 alkylethoxylate, and mixtures thereof.

6. The hard surface cleaning composition according to claim 1 wherein said ethoxylated nonionic surfactant is selected from the group consisting of: C₁₁ EO5 alkylethoxylate, C₉₋₁₁ EO8 alkylethoxylate, C10EO8 alkylethoxylate, C₁₂₋₁₄ EO7 alkylethoxylate, and mixtures thereof.

7. The hard surface cleaning composition according to claim 1, wherein said sulphated or sulphonated anionic surfactant is selected from the group consisting of alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof.

8. The hard surface cleaning composition according to claim 7, wherein said sulphated or sulphonated anionic surfactant is selected from the group consisting of alkyl sulphates (AS), sodium linear alkyl sulphonate (NaLAS), sodium paraffin sulphonate NaPC₁₂₋₁₆S, linear alkyl benzene sulfonate, and mixtures thereof.

9. The hard surface cleaning composition according to claim 8, wherein said sulphated or sulphonated anionic surfactant is selected from C₁₂₋₁₄ linear alkyl benzene sulfonate.

10. The hard surface cleaning composition according to claim 1, wherein the composition comprises less than about 6 by weight of alkyl ether sulphate anionic surfactant.

11. The hard surface cleaning composition according to claim 1, wherein said co-surfactant is an amine oxide surfactant according to the formula: R₁R₂R₃NO wherein each of R₁, R₂ and R₃ is independently a saturated or unsaturated, substituted or unsubstituted, linear or branched hydrocarbon chain of from about 10 to about 30 carbon atoms.

12. The hard surface cleaning composition according to claim 1, wherein the liquid composition herein comprises from about 0.01% to about 5.0% by weight of the total composition of said co-surfactant.

13. The hard surface cleaning composition according to claim 1, wherein the composition further comprises as ethoxylated alkoxylated nonionic surfactant selected from the group consisting of:
a) an esterified alkyl alkoxylated surfactant of formula (I): 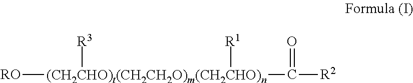
wherein:
R is a branched or unbranched alkyl radical having about 8 to about 16 carbon atoms;
R³, R¹ independently of one another, are hydrogen or a branched or unbranched alkyl radical having about 1 to about 5 carbon atoms;
R² is an unbranched alkyl radical having about 5 to about 17 carbon atoms;
1, n independently of one another, are a number from about 1 to about 5; and
m is a number from about 8 to about 50;
b) an alkyl ethoxy alkoxy alcohol of formula (II): 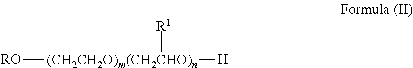
wherein:
R is a branched or unbranched alkyl radical having about 8 to about 16 carbon atoms;
R¹ is a branched or unbranched alkyl radical having about 1 to about 5 carbon atoms;
n is a number from about 1 to about 10; and
m is a number from about 6 to about 35.
c) and mixtures thereof,
and the ethoxylated alkoxylated nonionic surfactant provides a wetting effect of from about 60 to about 200, the wetting effect being measured according to EN 1772, using about 1 g/l of the ethoxylated alkoxylated nonionic surfactant in distilled water, at about 23° C., with about 2 g soda/l,

14. The hard surface cleaning composition according to claim 1, wherein the composition comprises from about 2% to about 16% by weight of the composition of said surfactant system.

15. The hard surface cleaning composition according to claim 14, wherein the composition comprises from about 5.0% to about 12.0% by weight of the composition of said surfactant system.

16. The hard surface cleaning composition according to claim 1, wherein the composition further comprises a cleaning polymer selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

17. The hard surface cleaning composition according to claim 1, wherein the composition further comprises from about 0.05% to about 5.0% by weight of the composition of a chelant, wherein said chelant is selected from the group consisting of diethylene triamine pentamethylene phosphonate (DTPMP), diethylene triamine pentaacetate (DTPA), L-glutamic acid N,N-diacetic acid (GLDA) and mixtures thereof.

18. The hard surface cleaning composition according to claim 1, wherein the composition further comprises from about 0.1% to about 10.0% by weight of the composition of a thickener.

19. The hard surface cleaning composition according to claim 18, wherein the composition has a viscosity of from about 25 Pa·s to about 1000 Pa·s, measured at about 20° C. with a AD1000 Advanced Rheometer from Atlas® with a shear rate of about 10 s⁻¹ with a coned spindle of about 40 mm with a cone angle of about 2° and a truncation of about 60 μm.

20. The hard surface cleaning composition according to claim 19, wherein the composition has a viscosity of from about 100 Pa·s to about 500 Pa·s.
